(19) United States
(12) Patent Application Publication
(10) Pub. No.: US 2024/0172804 A1
(43) Pub. Date: May 30, 2024

(54) AEROSOL GENERATING APPARATUS

(71) Applicant: KT&G CORPORATION, Daejeon (KR)

(72) Inventors: Dong Sung KIM, Seoul (KR); Yong Hwan KIM, Gyeonggi-do (KR); Seung Won LEE, Gyeonggi-do (KR); Seok Su JANG, Daejeon (KR); Dae Nam HAN, Seoul (KR)

(73) Assignee: KT&G CORPORATION, Daejeon (KR)

(21) Appl. No.: 18/283,381

(22) PCT Filed: Jun. 3, 2022
(86) PCT No.: PCT/KR2022/007940

§ 371 Date: Sep. 21, 2023

(30) Foreign Application Priority Data
Jun. 10, 2021 (KR) 10-2021-0075639

(51) Int. Cl. A24F 40/51; A24F 40/20; A24F 40/465; A24F 40/53; A24F 40/60; G08B 21/18; H05B 6/10; H05B 6/36

(52) U.S. Cl. CPC A24F 40/51; A24F 40/20; A24F 40/465; A24F 40/53; A24F 40/60; G08B 21/182; H05B 6/108; H05B 6/36

(57) ABSTRACT

An aerosol generating apparatus may include: a housing including a first chamber into which an aerosol generating article is inserted, a second chamber spaced apart from the first chamber, and an air path provided between the first chamber and the second chamber; a pressure sensor configured to detect a pressure in the second chamber; and a processor configured to obtain pressure sensing data from the pressure sensor, detect a pressure change inside the second chamber based on the pressure sensing data, and output a notification indicating that a user's puff operation has occurred when a pressure change inside the second chamber is greater than or equal to a designated value.

### TECHNICAL FIELD

Embodiments relate to an aerosol generating apparatus, and more particularly, to an aerosol generating apparatus including a pressure sensor to detect a user's puff operation through a pressure sensor.

### BACKGROUND ART

Recently, the demand for alternative methods to overcome the disadvantages of traditional cigarettes has increased. For example, there is growing demand for an aerosol generating device that generates an aerosol by heating or atomizing an aerosol generating material in a cigarette or a cartridge, instead of combusting a cigarette.

An aerosol generating apparatus may generate an aerosol by heating an aerosol generating article rather than supplying an aerosol by burning cigarettes. For example, the aerosol generating apparatus may generate an aerosol by heating an aerosol generating material in a liquid or solid state through a heater to a predetermined temperature.

When an aerosol generating apparatus is used, smoking can be performed without additional supplies such as a lighter, and a user's smoking convenience can be enhanced as a user can smoke as much as he/she wants. Thus, research on aerosol generating apparatuses has gradually increased.

### DISCLOSURE OF INVENTION

### Technical Problem

Generally, in an aerosol generating apparatus according to the related art, a heat source for heating an aerosol generating article and a printed circuit board are connected to each other via a thermocouple wire, and a user's puff operation is detected based on the temperature or current change of the heat source in a processor disposed on the printed circuit board.

In the above-described aerosol generating apparatus, in order to connect the heat source and the printed circuit board to each other via the thermocouple wire, the thermocouple wire needs to penetrate a structure (or a ‘sealed structure’) including the heat source. As the thermocouple wire penetrates the structure including the heat source, droplets may leak through the space of the structure through which the thermocouple wire penetrates, so that in the above-described aerosol production apparatus, it is difficult to prevent malfunction or damage of components of the aerosol generating apparatus due to droplets leakage.

An embodiment of the present disclosure provides an aerosol generating apparatus that may measure a pressure change of an air flow path through a pressure sensor and may detect a user's puff operation based on the pressure change of the air flow path so as to solve the problem of the aerosol generating apparatus for detecting the user's puff operation through a thermocouple wire.

The technical problems of the present disclosure are not limited to the above-described description, and other technical problems may be clearly understood by one of ordinary skill in the art from the embodiments to be described hereinafter.

### Solution to Problem

According to an aspect of the present disclosure, an aerosol generating apparatus may include: a housing including a first chamber into which an aerosol generating article is inserted, a second chamber spaced apart from the first chamber, and an air path provided between the first chamber and the second chamber, a pressure sensor configured to detect a pressure in the second chamber; and a processor configured to obtain pressure sensing data from the pressure sensor, detect a pressure change inside the second chamber based on the pressure sensing data, and output a notification indicating that a user's puff operation has occurred when the pressure change inside the second chamber is greater than or equal to a designated value.

The aerosol generating apparatus may further include a heater configured to heat the aerosol generating article inserted into the first chamber to generate an aerosol.

The aerosol generating apparatus may further include a heat insulating structure arranged to surround an outer circumferential surface of the heater and configured to seal the heater and to prevent dissipation of heat generated in the heater.

The pressure sensor may be spaced apart from the heat insulating structure.

The aerosol generating apparatus may further include an electrical connector arranged to bypass the heat insulating structure and configured to electrically connect the pressure sensor to the processor.

The pressure sensor may be located on a top end of the second chamber and is connected to an inside of the second chamber.

The aerosol generating apparatus may further include: a sensor bracket that supports the pressure sensor, and includes a through hole through which the pressure sensor and the second chamber are connected to each other, a sensor cover arranged to cover at least a portion of an outer circumferential surface of the pressure sensor and configured to dissipate heat transferred to the pressure sensor; and a protective member arranged to surround at least a portion of the outer circumferential surface of the pressure sensor between the sensor bracket and the sensor cover and configured to prevent leakage of air introduced into the pressure sensor.

The heater may include: a coil configured to generate an alternating magnetic field; and a susceptor configured to generate heat in response to the alternating magnetic field generated in the coil to heat the aerosol generating article.

The processor may be further configured to output the notification indicating that the user's puff operation has occurred, when a pressure drop of air inside of the second chamber is greater than or equal to the designated value.

The notification may include at least one of a visual notification, an audio notification, and a tactile notification.

The aerosol generating apparatus may further include a display, wherein the processor is further configured to display the notification indicating that the user's puff operation has occurred through the display.

The processor may be further configured to output an additional notification indicating that a number of times of remaining puffs of the inserted aerosol generating article based on a number of times of an occurrence of the user's puff operation.

According to another aspect of the present disclosure, an aerosol generating apparatus may include: a housing including a chamber into which an aerosol generating article is inserted, and an air path diverging from one point of the chamber in a direction crossing the chamber; a heater configured to heat the aerosol generating article inserted into the chamber to generate an aerosol; a pressure sensor configured to detect a pressure in the chamber; and a processor configured to obtain pressure sensing data from the pressure sensor, detect a pressure change of the chamber based on the pressure sensing data, and output a notification indicating that a user's puff operation has occurred when the pressure change inside the chamber is greater than or equal to a designated value.

The aerosol generating apparatus may further include a heat insulating structure arranged to surround an outer circumferential surface of the heater and configured to seal the heater to prevent dissipation of heat generated in the heater.

The pressure sensor may be spaced apart from the heat insulating structure.

### Advantageous Effects of Invention

The aerosol generating apparatus according to the above-described embodiments may provide a notification that a user's puff operation has occurred.

Furthermore, the aerosol generating apparatus according to the above-described embodiments may prevent malfunction or damage of a pressure sensor due to heat generated by a heat source. In addition, the aerosol generating apparatus according to the above-described embodiments may prevent malfunction or damage of components of the aerosol generating apparatus by leakage generated in an operation process.

However, effects of the present disclosure are not limited to the above effects, and effects that are not mentioned could be clearly understood by one of ordinary skill in the art from the present specification and the attached drawings.

### BRIEF DESCRIPTION OF DRAWINGS

FIG. 1 is a perspective view of an aerosol generating apparatus according to an embodiment.

FIG. 2 is a view schematically illustrating components of an aerosol generating apparatus according to an embodiment.

FIG. 3A is an enlarged cross-sectional view of some of components of an aerosol generating apparatus according to an embodiment.

FIG. 3B is a view for describing a movement process of air according to a user's puff operation in the aerosol generating apparatus shown in FIG. 3A.

FIG. 4 is a graph showing a pressure change of an air flow path according to a user's puff operation in the aerosol generating apparatus shown in FIG. 3A.

FIG. 5A is an enlarged cross-sectional view of some of components of an aerosol generating apparatus according to another embodiment.

FIG. 5B is a view for describing a movement process of air according to a user's puff operation in the aerosol generating apparatus shown in FIG. 5A.

FIG. 6 is a graph showing a pressure change of an air chamber according to a user's puff operation in the aerosol generating apparatus shown in FIG. 5A.

FIG. 7A is a perspective view illustrating an electrical connection member for electrically connecting a pressure sensor to a printed circuit board of an aerosol generating apparatus according to an embodiment.

FIG. 7B is a view for describing a combination relationship between a housing and an electrical connection member of an aerosol generating apparatus according to an embodiment.

FIG. 8 is a block diagram illustrating some components of an aerosol generating apparatus according to an embodiment.

FIG. 9 is a flowchart illustrating a process of detecting a user's puff operation of an aerosol generating apparatus according to an embodiment.

FIG. 10 is a view for describing a state in which a visual notification is provided through a display of an aerosol generating apparatus according to an embodiment.

FIG. 11 is a view illustrating an aerosol generating article according to an embodiment.

FIG. 12 is a view illustrating an aerosol generating article according to another embodiment.

### MODE FOR THE INVENTION

With respect to the terms used to describe the various embodiments, general terms which are currently and widely used are selected in consideration of functions of structural elements in the various embodiments of the present disclosure. However, meanings of the terms can be changed according to intention, a judicial precedence, the appearance of new technology, and the like. In addition, in certain cases, a term which is not commonly used can be selected. In such a case, the meaning of the term will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and/or operation and can be implemented by hardware components or software components and combinations thereof.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

In the present disclosure, an ‘aerosol’ may mean gas in a state in which vaporized particles generated from an aerosol generating material and the air are mixed with each other.

Also, in the present disclosure, an ‘aerosol generating apparatus’ may be an apparatus for generating an aerosol using an aerosol generating material so as to generate an aerosol that may be inhaled directly into a user's lungs through the user's mouth.

In the present disclosure, ‘puff means a user’s inhalation, and inhalation may mean a situation in which the user pulls the aerosol into the user's oral cavity, the nasal cavity or lungs through the user's mouth or nose.

As will be described below, embodiments of the present disclosure will be described in detail with reference to the accompanying drawings so that those skilled in the art may easily implement the embodiments in the technical fields of the present disclosure. However, the embodiments of the present disclosure may be implemented in various different forms and are not limited to the embodiments described herein.

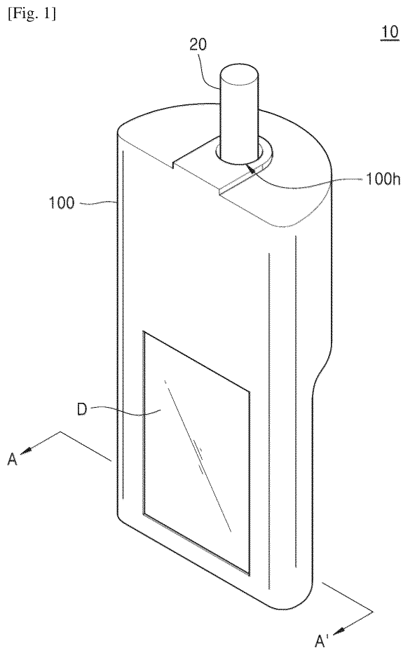

FIG. 1 is a perspective view of an aerosol generating apparatus according to an embodiment.

Referring to FIG. 1, an aerosol generating apparatus 10 according to an embodiment may include a housing 100, and an aerosol generating article 20 may be inserted into the housing 100.

The housing 100 may constitute the overall appearance of the aerosol generating apparatus 10, and may provide an internal space (or an ‘arrangement space’) to accommodate components of the aerosol generating apparatus 10 therein. In the drawings, the housing 100 is shown only for an embodiment in which the cross-section is formed in a semicircular shape, but the shape of the housing 100 is not limited thereto. According to an embodiment, the housing 100 may be formed entirely in a cylindrical form or a polygonal column (e.g., a triangular column or a square column).

Components for generating an aerosol by heating the aerosol generating article 20 inserted into the housing 100, and components for detecting the user's puff operation may be arranged in the internal space of the housing 100, and a detailed description thereof will be provided later.

According to an embodiment, the housing 100 may include an opening 100h through which the aerosol generating article 20 may be inserted into the housing 100. At least a portion of the aerosol generating article 20 may be inserted into or accommodated in the housing 100 through the opening 100h.

As the aerosol generating article 20 inserted into or accommodated in the housing 100 is heated inside the housing 100, an aerosol may be generated. The generated aerosol may be discharged to the outside of the aerosol generating apparatus 10 through the inserted aerosol generating article 20 and a space between the aerosol generating article 20 and the opening 100h, and the user may inhale the discharged aerosol.

The aerosol generating apparatus 10 according to an embodiment may further include a display D on which visual information is displayed.

According to an embodiment, the display D may be arranged so that at least a portion of the display D may be exposed to the outside of the housing 100, and the aerosol generating apparatus 10 may provide various visual information to the user through the display D.

For example, the aerosol generating apparatus 10 may provide information regarding whether the user's puff operation has occurred through the display D, or information about the number of times of remaining puffs of the inserted aerosol generating article 20. However, the information provided through the display D is not limited to the above-described embodiment.

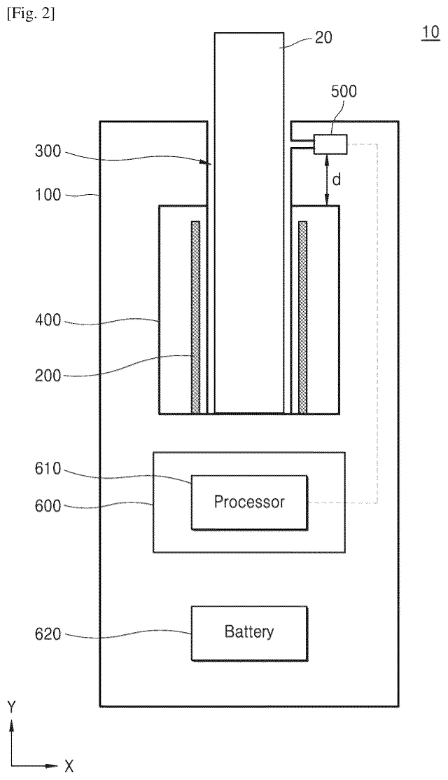

FIG. 2 is a view schematically illustrating components of an aerosol generating apparatus according to an embodiment. FIG. 2 is a cross-sectional view of the aerosol generating apparatus shown in FIG. 1 taken along a line A-A′ and illustrates some configuration arranged inside a housing.

Referring to FIG. 2, an aerosol generating apparatus 10 according to an embodiment may include a housing 100 (e.g., the housing 100 of FIG. 1), a heater 200, a first chamber 300, a heat insulating structure 400, and a pressure sensor 500. Components of the aerosol generating apparatus 10 according to an embodiment are not limited thereto, and according to an embodiment, another component (e.g., a vaporizer) may be added or at least one component may be omitted.

The housing 100 may include an internal space to accommodate components of the aerosol generating apparatus 10, and may constitute the overall appearance of the aerosol generating apparatus 10. In the drawings, the housing 100 is shown only for an embodiment in which the cross-section is formed in a semicircular shape, but the shape of the housing 100 is not limited thereto. According to an embodiment, the housing 100 may be formed entirely in a cylindrical form or a polygonal column (e.g., a triangular column or a square column).

According to an embodiment, the housing 100 may include an opening 100h and the aerosol generating article 20 may be inserted into the housing 100 through the opening 100h. At least a portion of the aerosol generating article 20 may be inserted into or accommodated in the housing 100 through the opening 100h.

A heater 200 may heat the aerosol generating article 20 inserted into or accommodated in the housing 100 through the opening 100h to generate an aerosol. The heater 200 may generate heat by the supply of power, for example, to heat the aerosol generating article 20. In this case, vaporized particles generated by heating the aerosol generating article 20 and the air introduced into the housing 100 through the opening 100h may be mixed with each other so that an aerosol may be generated.

According to an embodiment, the heater 200 may include an induction heating type heater. For example, the heater 200 may include a coil (or an ‘electrically conductive coil’) that generates an alternating magnetic field as power is supplied, and a susceptor that generates heat in response to the alternating magnetic field generated by the coil. The susceptor may be arranged to surround at least a portion of an outer circumferential surface of the aerosol generating article 20 inserted into the housing 100 and may heat the inserted aerosol generating article 20.

According to another embodiment, the heater 200 may include an electrical resistive heater. For example, the heater 200 may include a film heater arranged to surround at least a portion of the outer circumferential surface of the aerosol generating article 20 inserted into the housing 100. The film heater may include an electrically conductive track, and as current flows through the electrically conductive track, the film heater may generate heat to heat the aerosol generating article 20 inserted into the housing 100.

According to another embodiment, the heater 200 may include at least one of a needle type heater, a rod type heater, and a tube type heater that may heat the inside of the aerosol generating article 20 inserted into the housing 100. The above-described heater may be inserted into at least one region of the aerosol generating article 20, for example, to heat the inside of the aerosol generating article 20.

The heater 200 is not limited to the above-described embodiments, and an embodiment of the heater 200 may vary if the aerosol generating article 20 is heated to a designated temperature of the aerosol generating article 20. In the present disclosure, the ‘designated temperature’ may mean temperature at which the aerosol generating material included in the aerosol generating article 20 may be heated and thus an aerosol may be generated. The designated temperature may be temperature preset in the aerosol generating apparatus 10, but the corresponding temperature may be changed by the type of the aerosol generating apparatus 10 and/or the user's manipulation.

A first chamber 300 (or an ‘air flow path’) may be located in the internal space of the housing 100 and may connect the heater 200 to an outside of the housing 100 or an outside of the aerosol generating apparatus 10 or may communicate therewith. According to an embodiment, the first chamber 300 may extend in a lengthwise direction of the housing 100, and one end of the first chamber 300 may be connected to the heater 200, and the other end of the first chamber 300 may be connected to the opening 100h.

At least a portion of the aerosol generated in the heater 200 may pass through the aerosol generating article 20 inserted into the housing 100, or may move along the first chamber 300 and may be discharged to the outside of the housing 100 or the aerosol generating apparatus 10 through the opening 100h. Also, outside air of the aerosol generating apparatus 10 (hereinafter, an ‘outside air’) may be introduced into the housing 100 through the opening 100h and may move in a direction toward the heater 200 along the first chamber 300.

A heat insulating structure 400 may be arranged to surround the outer circumferential surface of the heater 200 and may prevent heat generated in the heater 200 from being discharged to the outside. In an embodiment, the heat insulating structure 400 may include a vacuum insulation layer arranged to surround the heater 200 to vacuum insulate the heater 200, however, embodiments are not limited thereto.

In an embodiment, the heat insulating structure 400 may prevent heat generated in the heater 200 from being discharged to the outside so that the temperature of the heater 200 may be maintained at a high temperature and as such, the amount of power required to operate the heater 200 may be reduced.

In another example, the heat insulating structure 400 may prevent heat generated in the heater 200 from being discharged to the outside so that the amount of heat transferred from the heater 200 to the housing 100 may be reduced. The aerosol generating apparatus 10 may reduce the temperature that may be detected when the user grasps the aerosol generating apparatus 10 through the above-mentioned heat insulating structure 400, so that the use convenience of the aerosol generating apparatus 10 may be enhanced.

In another example, the heat insulating structure 400 may seal the heater 200 to prevent droplets that may be generated in the operation process of the aerosol generating apparatus 10 from leaking to the outside of the heat insulating structure 400.

Droplets may be generated by agglomeration of some aerosol in a process of generating an aerosol of the heater 200, and the generated droplets may cause malfunction or damage of components of the aerosol generating apparatus 10. For example, when the droplets generated in the process of generating the aerosol flow into a printed circuit board 600, malfunction or damage of the printed circuit board 600 may occur.

The aerosol generating apparatus 10 according to an embodiment may prevent the droplets generated in the process of generating the aerosol of the heater 200 through the heat insulating structure 400 for sealing the heater 200 from leaking to the outside, so that malfunction or damage of the components of the aerosol generating apparatus 10 by the droplets may be prevented.

The pressure sensor 500 may be spaced apart from the first chamber 300 and may be electrically or operatively connected to the first chamber 300 to detect a pressure change according to the user's puff operation. For example, the pressure sensor 500 may be connected to the first chamber 300 through an air path to detect the pressure change of the first chamber 300.

According to an embodiment, the pressure sensor 500 may be spaced apart from the heat insulating structure 400 by a designated distance (e.g., distance ‘d’ of FIG. 2) so as to prevent malfunction or damage by heat generated in the heater 200. For example, the pressure sensor 500 may be spaced apart from the heat insulating structure 400 in a direction toward the opening 100h or a lengthwise direction (e.g., a y-direction) and may be disposed on a top end of the heat insulating structure 400.

In the present disclosure, the ‘top end’ may mean an end of the aerosol generating apparatus 10 in the (positive) y-direction of FIG. 2, a ‘bottom end’ may mean another end of the aerosol generating apparatus 10 in a negative y-direction, and the corresponding expressions may be used in the same sense in the following description.

When the pressure sensor 500 is greater than or equal to the designated temperature (e.g., about 70° C. to about 80° C.), the measurement accuracy of the pressure sensor 500 may be lowered, or malfunction of the pressure sensor 500 may occur. In particular, when the pressure sensor 500 is arranged adjacent to the heater 200 and/or the heat insulating structure 400, if the temperature around the heater 200 rises to a high temperature by the heat insulating structure 400, a situation in which the pressure sensor 500 is damaged by the high temperature around the heater 200, may occur.

In the aerosol generating apparatus 10 according to an embodiment, the pressure sensor 500 may be spaced apart from the heat insulating structure 400, by the designated distance to prevent that the pressure sensor 500 is overly heated up and malfunctions by the heat generated from the heater 200. That is, in the aerosol generating apparatus 10 according to an embodiment, the measurement accuracy of the pressure sensor 500 may be maintained through the above-described arrangement structure so that the pressure change of the first chamber 300 according to the user's puff operation may be accurately detected.

The aerosol generating apparatus 10 according to an embodiment may further include a processor 610 and a battery 620.

The processor 610 may control the operation of the aerosol generating apparatus 10. In an example, the processor 610 may be electrically or operatively connected to the heater 200 to control the operation of the heater 200. In another example, the processor 610 may be electrically or operatively connected to the pressure sensor 500 to detect the user's puff operation based on the detection result of the pressure sensor 500.

In the present disclosure, the expression ‘operatively connected’ may mean a state in which components are connected to transmit and receive signals in a wireless communication manner or to transmit and receive optical signals and/or magnetic signals, and the corresponding expressions may be used in the same sense even in the following.

According to an embodiment, the processor 610 may be arranged or mounted on the printed circuit board 600 located in the internal space of the housing 100, and the arrangement of the processor 610 is not limited to the above-described embodiment.

The battery 620 may supply power required for the operation of the aerosol generating apparatus 10. For example, the battery 620 may supply power to the heater 200 to operate the heater 200. In another example, the battery 620 may supply power required for the operation of the processor 610 or may supply power required for the operation of the pressure sensor 500.

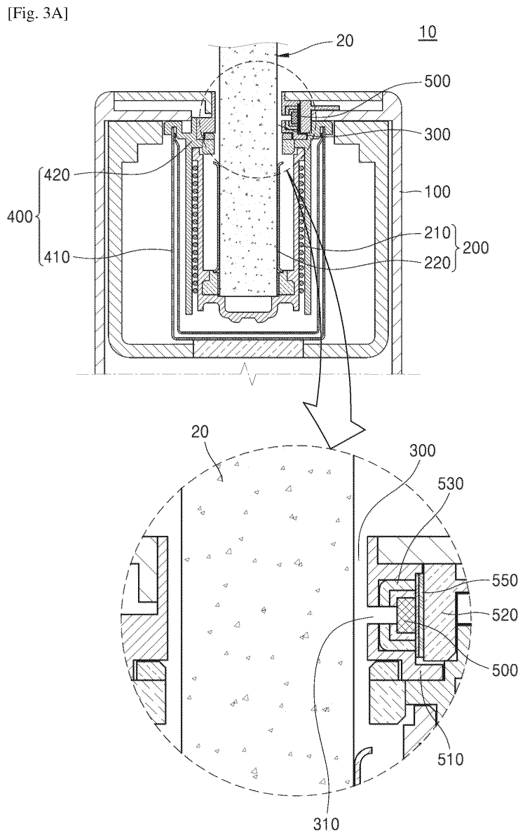

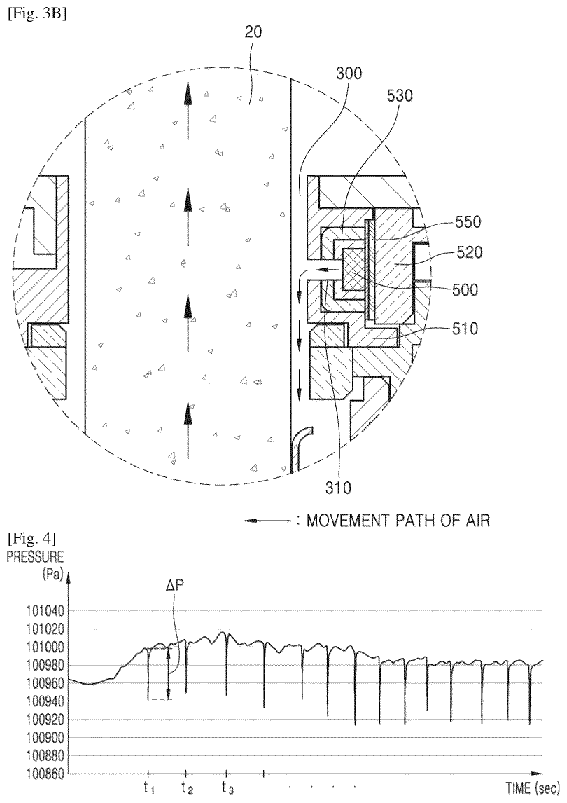

FIG. 3A is an enlarged view of some components of a cross-section of an aerosol generating apparatus according to an embodiment, FIG. 3B is a view for describing a movement process of air according to a user's puff operation in the aerosol generating apparatus shown in FIG. 3A, and FIG. 4 is a graph showing a pressure change of an air flow path according to the user's puff operation in the aerosol generating apparatus shown in FIG. 3A.

Referring to FIGS. 3A and 3B, an aerosol generating apparatus 10 according to an embodiment may include a housing 100, a heater 200, a first chamber 300, an air path 310, a heat insulating structure 400, a pressure sensor 500, and a processor (e.g., the processor 610 of FIG. 2). The aerosol generating apparatus 10 shown in FIGS. 3A and 3B may be an embodiment of the aerosol generating apparatus 10 of FIG. 2.

The heater 200 may be located inside the housing 100 and may heat the aerosol generating article 20 inserted into the housing 100 to generate an aerosol.

According to an embodiment, the heater 200 may include a coil 210 (or an ‘electrically conductive coil’) and a susceptor 220, as shown in FIG. 3A, to heat the aerosol generating article 20 inserted into the housing 100 by an induction heating method.

The coil 210 may be disposed to surround an outer circumferential surface of the susceptor 220 and may generate an alternating magnetic field through power supplied by a battery (e.g., the battery 620 of FIG. 1).

The susceptor 220 may be disposed to surround at least a portion of the outer circumferential surface of the aerosol generating article 20 inserted into the housing 100 and may heat the aerosol generating article 20 inserted into the housing 100. The susceptor 220 may generate heat, for example, in response to an alternating magnetic field generated in the coil 210, and as a result, the aerosol generating article 20 may be heated.

However, the embodiment of the heater 200 is not limited to the above-described embodiment, and according to an embodiment, the heater 200 may include an electrical resistive heater that may heat the inside and/or the outside of the aerosol generating article 20 inserted into the housing 100.

The heat insulating structure 400 may be arranged to surround the outer circumferential surface of the heater 200 and may seal the heater 200 to prevent droplets generated in the process of generating an aerosol from leaking to the outside. Also, the heat insulating structure 400 may seal the heater 200 to prevent heat generated in the heater 200 from passing through the heat insulating structure 400 and thereby being discharged to the outside so that the ambient temperature of the heater 200 may be maintained at a high temperature.

According to an embodiment, the heat insulating structure 400 may include a first structure 410 arranged to surround one region (e.g., a bottom end surface and/or a side surface) of an outer circumferential surface of the heater 200, and a second structure 420 that is located on the top end of the first structure 410 and covers another region (e.g., a top end surface) of the outer circumferential surface of the heater 200.

The heater 200 may be located in an internal space formed by the first structure 410 and the second structure 420, and the first structure 410 and the second structure 420 may seal the above-described heater 200. In an example, the second structure 420 may be coupled to at least one region of the top end of the first structure 410, but embodiments are not limited thereto. In another example, the first structure 410 and the second structure 420 may be integrally formed.

The first chamber 300 may be disposed to connect the inside of the housing 100 to the outside of the housing 100 or the outside of the aerosol generating apparatus 10. The first chamber 300 may function as a flow path of the air or the aerosol from the inside to the outside of the aerosol generating apparatus 10 or from the outside to the inside of the aerosol generating apparatus 10.

In an embodiment, the aerosol generated inside the aerosol generating apparatus 10 may pass through the aerosol generating article 20 inserted into the housing 100 or may move along the first chamber 300 and may be discharged to the outside of the aerosol generating apparatus 10 or the housing 100. In another example, the outside air of the aerosol generating apparatus 10 (hereinafter, an ‘outside air’) may be introduced into the internal space of the housing 100 through the first chamber 300.

The pressure sensor 500 may be spaced apart from the first chamber 300 by a designated distance and may be connected to the first chamber 300 through the air path 310 to detect the pressure change of the first chamber 300. For example, the pressure sensor 500 may be spaced apart from the first chamber 300 by about 0.5 mm to about 10 mm, but embodiments are not limited thereto.

The pressure sensor 500 may generate an electrical signal corresponding to the pressure change of the first chamber 300, and the electrical signal generated by the pressure sensor 500 may be transmitted to a processor (e.g., the processor 610 of FIG. 2) electrically or operatively connected to the pressure sensor 500.

According to an embodiment, the pressure sensor 500 may be arranged on a sensor printed circuit board 550 and may be electrically connected to the processor arranged on a printed circuit board through an electrical connection member for connecting the sensor printed circuit board 550 to the printed circuit board (e.g., the printed circuit board 600 of FIG. 2).

The air flow path 310 may diverge from one point of the first chamber 300 in a direction (e.g., an x-direction of FIG. 2) crossing the first chamber 300 to connect the first chamber 300 to the pressure sensor 500. For example, the air path 310 may be formed to have the cross-sectional area of about 0.8 mm2 to about 12 mm2 to connect the first chamber 300 to the pressure sensor 500. However, embodiments are not limited thereto.

The pressure sensor 500 may be connected to the first chamber 300 through the air path 310 to detect the pressure change of the first chamber 300. The pressure sensor 500 may detect, for example, the pressure of the air path 310 that is connected to or fluid-connected to the first chamber 300, to detect the pressure change of the first chamber 300.

The processor may be electrically or operatively connected to the pressure sensor 500 and may detect the user's puff operation based on the pressure change of the first chamber 300 detected by the pressure sensor 500.

According to an embodiment, the processor may detect the user's puff operation based on a pressure drop of the first chamber 300 detected by the pressure sensor 500.

Due to the user's puff operation, at least a portion of the air of the first chamber 300 and/or the air path 310 may pass through the aerosol generated article 20 and may be discharged to the outside of the housing 100, as shown in FIG. 3B.

Due to the user's puff operation, a pressure difference between the outside of the housing 100 and the inside of the housing 100 may occur. As a result, at least a portion of the air of the first chamber 300 and/or the air path 310 may be discharged to the outside of the housing 100 so that a pressure drop may occur in the first chamber 300.

Referring to the graph of FIG. 4, as the flow of the air is formed on the first chamber 300 and/or the air path 310 due to the user's puff operation, the pressure of the first chamber 300 may be reduced by about 60 Pa to about 80 Pa, and the pressure sensor 500 may detect the pressure drop of the first chamber 300.

In FIG. 4, parameters, ‘t1, t2, t3, . . . ,’ represent certain points in time at which the user's puff operation is detected, and at which pressure drop may occur in the first chamber 300 due to the user's puff operation. the particular points in time at which the user's puff operation is detected, are illustrated in FIG. 4 as examples, and embodiments of the present disclosure are not limited thereto.

Thus, the processor may detect the user's puff operation based on the pressure drop of the first chamber 300 detected by the pressure sensor 500. The processor may compare, for example, the pressure drop of the first chamber 300 detected by the pressure sensor 500 with a designated value (e.g., ΔP of FIG. 4), and may determine that the user's puff operation has been performed, when the pressure drop of the first chamber 300 is greater than or equal to the designated value ΔP.

In the present disclosure, the ‘designated value ΔP’ may mean the pressure drop that is a base (or a reference value) for detecting the user's puff operation. The above-described designated value ΔP may be a value previously-stored in the aerosol generating apparatus 10 and may vary according to the type of the aerosol generating apparatus 10 or the user's settings. For example, the designated value ΔP may be about 60 Pa to about 80 Pa, but embodiments are not limited thereto. Also, the designated value ΔP shown in FIG. 4 corresponds to an embodiment of the present disclosure, and in various embodiments of the present disclosure, the designated value ΔP is not limited to the value shown in FIG. 4.

The aerosol generating apparatus 10 according to an embodiment may determine that the user's puff operation has been performed only when the pressure drop of the first chamber 300 is greater than or equal to the designated value ΔP so that the user's puff operation may be more accurately measured.

The pressure drop of the first chamber 300 may be caused by other reasons (e.g., noise generated during the operation of the aerosol production apparatus 10), in addition to the user's puff operation. For example, when the user moves, walks, or runs while holding the aerosol generating apparatus 10, such movements may cause the aerosol generating apparatus 10 to vibrate, and a pressure drop may occur in the aerosol generating apparatus 10 even though the user does not inhale an aerosol of the aerosol generating apparatus 10. The aerosol generating apparatus 10 may detect a pressure drop caused by the user's puff operation, and may ignore a pressure drop caused by other reasons (e.g., noise or vibration), based on a comparison between a measured pressure drop and the designated value ΔP.

The aerosol generating apparatus 10 according to an embodiment may not misrecognize the pressure drop of the first chamber 300 by the noise as pressure drop by the user's puff operation through the above-described operation of the processor.

Also, the pressure sensor 500 may be spaced apart from the heat insulating structure 400 by the designated distance so as to prevent malfunction or damage by heat. For example, the pressure sensor 500 may be located on the top end of the heat insulating structure 400. The top end of the heat insulating structure 400 may mean a region adjacent to the end of the upper portion of the heat insulating structure 400 toward an opening (e.g., the opening 100h of FIG. 2) through which the aerosol generating article 20 is inserted.

When the temperature of the pressure sensor 500 reaches the designated temperature or higher, a situation in which the measurement accuracy of the pressure sensor 500 may be lowered by heat or the pressure sensor 500 is broken, may occur. In particular, when the pressure sensor 500 is arranged adjacent to the heat insulating structure 400 for sealing the heater 200, malfunction or failure of the pressure sensor 500 may occur by high-temperature heat generated in the heater 200.

In the aerosol generating apparatus 10 according to an embodiment, the pressure sensor 500 may be spaced apart from the heat insulating structure 400 in a top end direction (e.g., a y-direction of FIG. 2) of the heat insulating structure 400 so that malfunction or failure of the pressure sensor 500 by heat generated by the heater 200 may be prevented.

The aerosol generating apparatus 10 according to an embodiment may further include a sensor bracket 510, a sensor cover 520 and/or a protective member 530 so as to prevent malfunction or failure of the pressure sensor 500 by heat. However, according to an embodiment, at least one configuration of the above-described components may be omitted.

The sensor bracket 510 may be disposed to surround at least one region of the pressure sensor 500 to support or fix the pressure sensor 500 and to prevent heat generated in the heater 200 from being transferred to the pressure sensor 500. For example, the sensor bracket 510 may be disposed to surround one region toward the first chamber 300 of the pressure sensor 500, however, the arrangement structure of the sensor bracket 510 is not limited to the above-described embodiment.

According to an embodiment, the sensor bracket 510 may include a through hole 510h that connects the air flow path 310 to the pressure sensor 500, and the pressure sensor 500 may be connected to or fluid-connected to the first chamber 300 through the air flow path 310 and the through hole 510h.

The sensor cover 520 may be disposed to cover at least one region of the pressure sensor 500 to support the pressure sensor 500. Also, the sensor cover 520 may include a material having thermal conductivity and may perform a function of dissipating heat transferred to the pressure sensor 500. For example, at least a portion of heat generated in the heater 200 may be transferred to the pressure sensor 500 through convection and/or radiation, and the sensor cover 520 may transfer heat transferred to the pressure sensor 500 to an outside (e.g., the housing 100) of the pressure sensor 500.

According to an embodiment, the sensor cover 520 may be located in an opposite direction to the sensor bracket 510 based on the pressure sensor 500 to support another region of the pressure sensor 500. However, the arrangement structure of the sensor cover 520 is not limited to the above-described embodiment.

The protective member 530 may be disposed to surround at least a portion of the outer circumferential surface of the pressure sensor 500 to protect the pressure sensor 500 and to prevent the air introduced into the pressure sensor 500 from the first chamber 300 from leaking. For example, the protective member 530 may include a material (e.g., rubber) having elastic characteristics to protect the pressure sensor 500 and to prevent the air introduced into the pressure sensor 500 from leaking to the outside of the pressure sensor 500.

According to one embodiment, the protective member 530 may be disposed between the sensor bracket 510 and the sensor cover 520, but when the protective member 530 may protect the pressure sensor 500 and may prevent leakage of the air introduced into the pressure sensor 500, the arrangement position of the protective member 530 is not limited thereto.

That is, the aerosol generating apparatus 10 according to an embodiment may insulate and/or heat-dissipate the pressure sensor 500 through the above-described sensor bracket 510 and/or the sensor cover 520, thereby preventing malfunction or failure of the pressure sensor 500 by heat. As a result, the aerosol generating apparatus 10 may enhance measurement accuracy of the pressure sensor 500, thereby detecting the user's puff operation more accurately.

The aerosol generating apparatus 10 may further include a heat dissipation plate that is located between the pressure sensor 500 and the sensor bracket 510 and dissipates heat transferred to the pressure sensor 500 to the outside. The heat dissipation plate may include, for example, a material having high thermal conductivity, and may transfer heat transferred to the pressure sensor 500 to the outside of the pressure sensor 500.

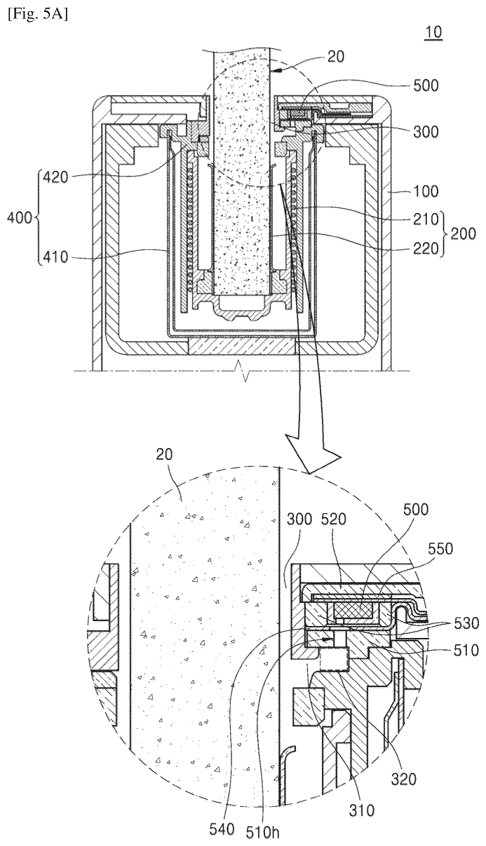

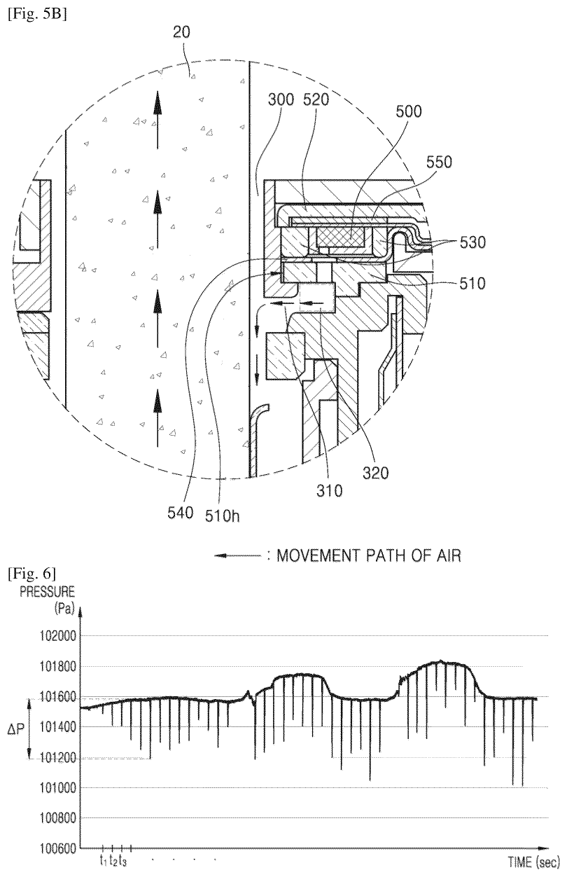

FIG. 5A is an enlarged view of some components of a cross-section of an aerosol generating apparatus according to another embodiment, FIG. 5B is a view for describing a movement process of the air according to a user's puff operation in the aerosol generating apparatus shown in FIG. 5A, and FIG. 6 is a graph showing a pressure change of an air chamber according to the user's puff operation in the aerosol generating apparatus shown in FIG. 5A.

In FIG. 6, parameters, ‘t1, t2, t3, . . . ’ represent certain points in time at which the user's puff operation is detected, and ‘ΔP’ may mean a designated value. Also, the particular points in time at which the user's puff operation is detected, are illustrated in FIG. 6 as examples, and embodiments of the present disclosure are not limited thereto.

Referring to FIGS. 5A and 5B, an aerosol generating apparatus 10 according to another embodiment may include a housing 100, a heater 200, a first chamber 300, an air flow path 310, a second chamber 320, a heat insulating structure 400, a pressure sensor 500, and a processor (e.g., the processor 610 of FIG. 2). The aerosol generating apparatus 10 according to another embodiment may be an aerosol generating apparatus in which the second chamber 320 is added to the aerosol generating apparatus 10 of FIG. 3A and/or FIG. 3B and the arrangement position of the pressure sensor 500 is changed.

The first chamber 300 may be disposed to connect the inside of the housing 100 to the outside of the housing 100 or the outside of the aerosol generating apparatus 10 and thus may function as a flow path on which the air or the aerosol moves from the inside to the outside of the aerosol generating apparatus 10 or from the outside to the inside of the aerosol generating apparatus 10.

In an example, the aerosol generated inside the aerosol generating apparatus 10 may pass through the aerosol generating article 20 inserted into the housing 100 or may move along the first chamber 300 and may be discharged to the outside of the aerosol generating apparatus 10 or the housing 100. In another example, the outside air of the aerosol generating apparatus 10 (hereinafter, ‘outside air’) may be introduced into the internal space of the housing 100 through the first chamber 300.

The second chamber 320 (or ‘air chamber’) may be spaced apart from the first chamber 300 by a designated distance and may be connected to or fluid-connected to the first chamber 300 through the air flow path 310. The second chamber 320 may be spaced apart from the first chamber 300 in a direction crossing the lengthwise direction of the housing 100 and may be arranged in an independent space of the first chamber 300.

The air path 310 may diverge from one point of the first chamber 300 in a direction crossing the first chamber 300 and may connect the first chamber 300 and the second chamber spaced apart from the first chamber 300 to each other or may communicate therewith. For example, one end of the air path 310 may be connected to the first chamber 300, and the other end of the air path 310 may be connected to the second chamber 320 so that the first chamber 300 and the second chamber 320 may be connected to each other.

The air of the first chamber 300 may move along the air path 310 through the above-mentioned connection structure to be introduced into the second chamber 320, or the air of the second chamber 320 may be discharged to the first chamber 300 through the air path 310. That is, the air path 310 may function as an air movement path between the first chamber 300 and the second chamber 320.

The pressure sensor 500 may be spaced apart from the first chamber 300 by a designated distance and may be located in one region adjacent to the second chamber 320 to detect a pressure change of the air accommodated in the second chamber 320. For example, the pressure sensor 500 may be connected to or fluid-connected to the internal space of the second chamber 320 to detect the pressure change of the air accommodated in the second chamber 320.

According to an embodiment, the pressure sensor 500 may generate an electrical signal corresponding to the pressure change of the air accommodated in the internal space of the second chamber 320, and the electrical signal generated in the pressure sensor 500 may be transmitted to a processor that is operatively connected to the pressure sensor 500.

In an example, the pressure sensor 500 may be arranged on the sensor printed circuit board 550 and may be electrically connected to the processor arranged on the printed circuit board through an electrical connection member for connecting the sensor printed circuit board 550 to the printed circuit board (e.g., the printed circuit board 600 of FIG. 2). However, a detailed description thereof will be provided later.

According to an embodiment, the pressure sensor 500 may be spaced apart from the heat insulating structure 400 by a designated distance and may prevent malfunction or failure of the pressure sensor 500 by heat transferred from the heater 200 and/or the heat insulating structure 400.

When the pressure sensor 500 is arranged adjacent to the heater 200 and/or the heat insulating structure 400 in which a high-temperature environment is maintained, the pressure sensor 500 may malfunction or may be broken by heat transferred to the pressure sensor 500 from the heater 200 and/or the heat insulating structure 400.

In the aerosol generating apparatus 10 according to an embodiment, the second chamber 320 and the pressure sensor 500 may be spaced from the heat insulating structure 400 by the designated distance so that the amount of heat transferred to the pressure sensor 500 may be reduced. As a result, the aerosol generating apparatus 10 may prevent malfunction or failure of the pressure sensor 500 by heat through the above-described structure.

The pressure sensor 500 may be spaced apart from the heat insulating structure 400 in a direction (e.g., a y-direction of FIG. 2) toward the top end of the heat insulating structure 400 based on the heat insulating structure 400. However, the arrangement structure of the pressure sensor 500 is not limited to the above-described embodiment. The direction toward the top end of the heat insulating structure 400 may be a direction toward an opening through which the aerosol generating article 20 is inserted into the housing 100.

Also, the pressure sensor 500 may be located at the top end of the second chamber 320 spaced apart from the first chamber 300 to reduce the amount of heat transferred from the heater 200 and/or the heat insulating structure 400.

The top end of the second chamber 320 may mean an upper end of the second chamber 320 or an opposite end to one end of the second chamber 320 toward the heat insulating structure 400 based on a direction in which the aerosol generating article extends.

For example, when the pressure sensor 500 is disposed on the side surface or bottom end of the second chamber 320, a distance between the pressure sensor 500 and the heater 200 and/or the heat insulating structure 400 in which the high-temperature environment is maintained, may be reduced so that a situation in which the pressure sensor 500 malfunctions or is broken by heat transferred from the heater 200 and/or the heat insulating structure 400, may occur.

On the other hand, in the aerosol generating apparatus 10 according to an embodiment, the pressure sensor 500 may be located on the top end of the second chamber 320 so that the distance between the pressure sensor 500 and the heater 200 and/or the heat insulating structure 400 may be increased compared to a case where the pressure sensor 500 is disposed on the bottom end or the side surface of the second chamber 320. As a result, the aerosol generating apparatus 10 may reduce the amount of heat transferred to the pressure sensor 500 from the heater 200 and/or the heat insulating structure 400 through the arrangement structure of the above-described pressure sensor 500 to prevent malfunction or failure of the pressure sensor 500 by heat may be prevented.

However, the arrangement structure of the pressure sensor 500 is not limited to the above-described embodiment, and according to an embodiment, the pressure sensor 500 may be disposed on the side surface or bottom end of the second chamber 320.

The aerosol generating apparatus 10 according to an embodiment may further include a sensor bracket 510, a sensor cover 520, a protective member 530 and/or a heat dissipation plate 540 so as to prevent malfunction or failure of the pressure sensor 500 by heat. However, according to an embodiment, at least one configuration (e.g., the heat dissipation plate 540) of the above-described components may be omitted.

The sensor bracket 510 may be disposed to surround at least one region of the pressure sensor 500 to support or fix the pressure sensor 500 and to prevent heat generated in the heater 200 from being transferred to the pressure sensor 500.

For example, the sensor bracket 510 may be located on the top end of the second chamber 320 to surround one region toward the second chamber 320 of the pressure sensor 500. However, the arrangement structure of the sensor bracket 510 is not limited to the above-described embodiment. In another example, when the pressure sensor 500 is disposed on the side surface or the bottom end of the second chamber 320, the sensor bracket 510 may be disposed on the side surface or the bottom end of the second chamber 320.

According to an embodiment, the sensor bracket 510 may include a through hole 510h that connects the second chamber 320 to the pressure sensor 500, and the pressure sensor 500 supported by the sensor bracket 510 may be connected to or fluid-connected to the second chamber 320 through the above-described through hole 510h.

The sensor cover 520 may be disposed to cover at least one region of the pressure sensor 500 to support the pressure sensor 500. Also, the sensor cover 520 may include a material having thermal conductivity and may perform a function of dissipating heat transferred to the pressure sensor 500. For example, at least a portion of heat generated in the heater 200 to the pressure sensor 500 may be transferred to the pressure sensor 500 through convection and/or radiation, and the sensor cover 520 may transfer heat transferred to the pressure sensor 500 to an outside (e.g., the housing 100) of the pressure sensor 500.

According to an embodiment, the sensor cover 520 may be located in an opposite direction to the sensor bracket 510 based on the pressure sensor 500 to support another region of the pressure sensor 500. However, the arrangement structure of the sensor cover 520 is not limited to the above-described embodiment.

The protective member 530 may be disposed to surround at least a portion of the outer circumferential surface of the pressure sensor 500 to protect the pressure sensor 500 and to prevent the air introduced into the pressure sensor 500 from the first chamber 300 from leaking. For example, the protective member 530 may include a material (e.g., rubber) having elastic characteristics to protect the pressure sensor 500 and to prevent the air introduced into the pressure sensor 500 from leaking to the outside of the pressure sensor 500.

According to one embodiment, the protective member 530 may be disposed between the sensor bracket 510 and the sensor cover 520, but when the protective member 530 may protect the pressure sensor 500 and may prevent leakage of the air introduced into the pressure sensor 500, the arrangement position of the protective member 530 is not limited thereto.

The heat dissipation plate 540 may be located between the pressure sensor 500 and the sensor bracket 510 and may include a material (e.g., aluminum) having high thermal conductivity and may dissipate heat transferred to the pressure sensor 500. For example, the heat dissipation plate 540 may transfer heat transferred to the pressure sensor 500 from the heater 200 and/or the heat insulating structure 400 to the outside of the pressure sensor 500 to dissipate heat transferred to the pressure sensor 500. However, embodiments are not limited thereto.

The processor may be electrically or operatively connected to the pressure sensor 500 and may detect the user's puff operation based on the amount of the pressure change of the air accommodated in the second chamber 320 detected by the pressure sensor 500.

According to an embodiment, the processor may detect the user's puff operation based on the pressure drop of the second chamber 320 detected by the pressure sensor 500.

Due to the user's puff operation, at least a portion of the air of the first chamber 300 and/or the second chamber 320 may pass through the aerosol generated article 20 and may be discharged to the outside of the housing 100, as shown in FIG. 5B.

For example, as the pressure of the outside of the housing 100 is reduced by the user's puff operation, a pressure difference between the inside of the housing 100 and the outside of the housing 100 may occur. As a result, at least a portion of the air of the first chamber 300 and/or the second chamber 320 may be discharged to the outside of the housing 100, and thus, a pressure drop may occur in the first chamber 300 and the second chamber 320.

Thus, the processor may detect the user's puff operation based on the pressure drop of the second chamber 320 detected by the pressure sensor 500. For example, the processor may compare the pressure drop of the second chamber 320 detected by the pressure sensor 500 with a designated value, and when the pressure drop of the second chamber 320 is greater than or equal to the designated value (e.g., ΔP of FIG. 6), the processor may determine that the user's puff operation has been performed.

The aerosol generating apparatus 10 according to an embodiment may detect the pressure change of the air accommodated in the second chamber 320 (not in the first chamber 300), thereby detecting the user's puff operation more accurately compared to a case where the pressure change of the first chamber 300 is detected.

As at least a portion of heat generated in the heater 200 and/or the heat insulating structure 400 is transferred into the second chamber 320 through the first chamber 300 and the air path 310, heat may be applied to the air accommodated in the second chamber 320 so that a kinetic energy of the air accommodated in the second chamber 320 may be increased. Unlike in the air present in the first chamber 300, the air accommodated in the second chamber 320 is present in a certain space, an increase in the kinetic energy of the air may cause an increase in the pressure of the second chamber 320.

As a result, the second chamber 320 may maintain a relatively high pressure compared to the first chamber 300 during an operation of the aerosol generating apparatus 10. For example, referring to the graphs of FIGS. 4 and 6 described above, the pressure of the first chamber 300 may be maintained in the range of about 100980 Pa to about 101020 Pa during the operation of the aerosol generating apparatus 10, whereas the pressure of the second chamber 320 may be maintained in the range of about 101600 Pa to about 101800 Pa that is higher than that of the first chamber 300.

As the second chamber 320 is maintained at a relatively high pressure compared to the first chamber 300, the pressure drop of the second chamber 320 according to the user's puff operation may be greater than the pressure drop of the first chamber 300. For example, referring back to the graphs of FIGS. 4 and 6, a pressure drop of about 40 Pa to about 60 Pa occurs in the first chamber 300 according to the user's puff operation, where a pressure drop of about 150 Pa to about 300 Pa may occur in the second chamber 320 according to the user's puff operation.

Noise may occur in the pressure sensor 500 according to an operating environment or an operating situation of the aerosol generating apparatus 10, and even when there is no user's puff operation, a situation in which the pressure drop of the second chamber 320 is detected by the pressure sensor 500, may occur.

In this case, when the pressure drop according to the user's puff operation is small, it is difficult to differentiate a pressure drop by noise and a pressure drop by the user's puff operation from each other so that a situation in which the aerosol generating apparatus 10 recognizes that the pressure drop by noise as a pressure drop by the user's puff operation, may occur.

On the other hand, the aerosol generating apparatus 10 according to an embodiment may detect the user's puff operation based on the pressure drop of the second chamber 320 having a large pressure drop according to the user's puff operation so that the pressure drop of the second chamber 320 by noise may not be misrecognized as the pressure drop by the user's puff operation. That is, the aerosol generating apparatus 10 according to an embodiment may detect the user's puff operation based on the pressure drop of the second chamber 320 so that misdetermination by noise may be reduced and the user's puff operation may be more accurately recognized.

Also, the aerosol generating apparatus 10 according to an embodiment may detect the user's puff operation based on the pressure change of the second chamber 320 so that the user's puff operation may be accurately detected without scaling-up the level of a signal of the pressure sensor 500 that changes according to the pressure change of the second chamber 320 (e.g., enlarging of the amplitude of the signal) or without amplifying a signal received from the pressure sensor 500.

That is, the aerosol generating apparatus 10 may detect the user's puff operation accurately even without a scaling-up or signal-amplifying operation, thereby reducing time required to detect the user's puff operation. Furthermore, the aerosol generating apparatus 10 may simplify a process of detecting the user's puff operation by using the processor to reduce power consumption of the processor. As a result, the operating time of the aerosol generating apparatus 10 may be increased.

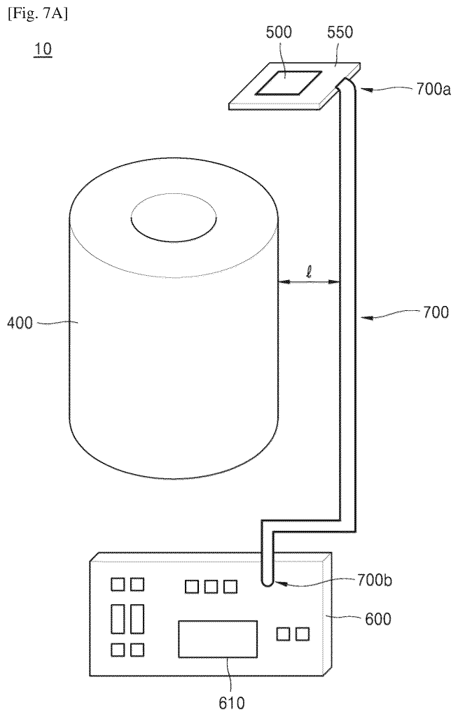

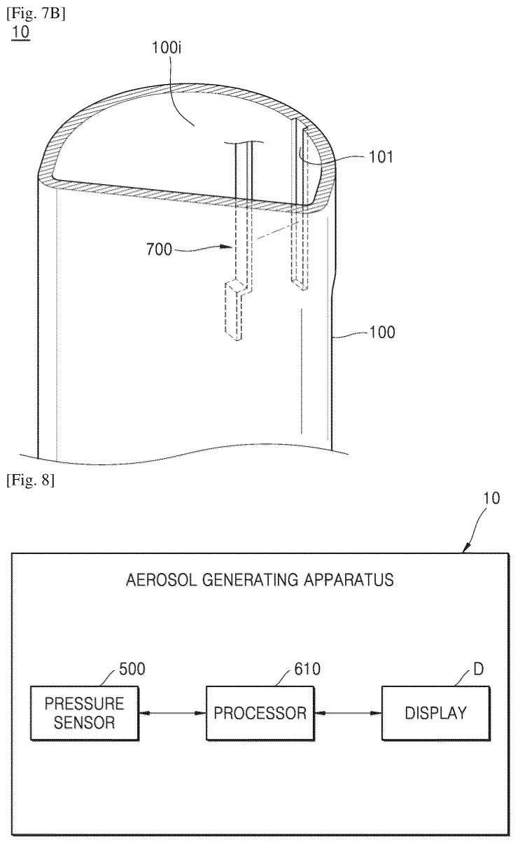

Hereinafter, a component for electrically connecting the pressure sensor 500 and the processor will be described in detail with reference to FIGS. 7A and 7B.

FIG. 7A is a perspective view illustrating an electrical connection member for electrically connecting a pressure sensor and a printed circuit board of an aerosol generating apparatus according to an embodiment, and FIG. 7B is a view for describing a combination relationship between a housing and an electrical connection member of an aerosol generating apparatus according to an embodiment.

An electrical connection member 700 shown in FIG. 7A and/or FIG. 7B may be included in the aerosol generating apparatus 10 of FIGS. 2, 3A and/or 5A.

Referring to FIG. 7A, an aerosol generating apparatus 10 according to an embodiment may include an electrical connection member 700 for electrically connecting the pressure sensor 500 and the processor 610.

According to an embodiment, the pressure sensor 500 may be disposed (or ‘mounted’) on the sensor printed circuit board 550, and the processor 610 may be arranged on the printed circuit board 600 spaced apart from the sensor printed circuit board 550.

The electrical connection member 700 may electrically connect the sensor printed circuit board 550 and the printed circuit board 600, thereby connecting the pressure sensor 500 disposed on the sensor printed circuit board 550 to the processor 610 disposed on the printed circuit board 600. For example, one end 700a of the electrical connection member 700 may be connected to the sensor printed circuit board 550, and the other end 700b of the electrical connection member 700 may be connected to the printed circuit board 600, thereby connecting the pressure sensor 500 to the processor 600 electrically or operatively.

According to an embodiment, the electrical connection member 700 may be a flexible printed circuit board (FPCB), but embodiments are not limited thereto. In another embodiment, the electrical connection member 700 may include at least one of an electric wire and a coaxial cable.

The electrical connection member 700 may be disposed to electrically or operatively connect the pressure sensor 500 to the processor 610 but may be arranged to avoid the heat insulating structure 400.

In the present disclosure, the expression ‘the electrical connection member is arranged to avoid the heat insulating structure’ may mean that the electrical connection member 700 is arranged to extend along an outside of the heat insulating structure 400 or the electrical connection member 700 is arranged to bypass the heat insulating structure 400 so that the electrical connection member 700 does not penetrate the heat insulating structure 400.

According to an embodiment, the electrical connection member 700 may electrically connect the pressure sensor 500 and the processor 610 in a state in which at least a region of the electrical connection member 700 is spaced apart from the heat insulating structure 400 by a certain distance I. However, embodiments are not limited thereto. According to another embodiment, at least a region of the electrical connection member 700 may be in contact with an outer circumferential surface of the heat insulating structure 400.

In an aerosol generating apparatus according to the related art, generally, a heater and a processor are connected to each other through a thermocouple wire, and a user's puff operation is detected based on a temperature or current change of a heater detected through the thermocouple wire.

In order to connect the thermocouple wire to the heater, the thermocouple wire needs to pass through some regions of the heat insulating structure 400 that surrounds the heater. When droplets are generated around the heater, the droplets are discharged to the outside of the heat insulating structure 400 through an internal space of the heat insulating structure 400 in which the thermocouple wire is accommodated. The discharged droplets may flow into other components in the aerosol generating apparatus 10, and may cause the components of the aerosol generating apparatus 10 to be damaged, in the related art.

In the aerosol generating apparatus 10 according to an embodiment, the users puff operation may be detected through the pressure sensor 500 that is not the thermocouple wire, and the pressure sensor 500 and the processor 610 may be connected to each other through the electrical connection member 700 arranged to avoid the heat insulating structure 400 so that droplets may be prevented from leaking to the outside of the heat insulating structure 400.

In other words, in the aerosol generating apparatus 10 according to an embodiment, the pressure sensor 500 and the processor 610 may be connected to each other without penetrating the heat insulating structure 400 through the above-described electrical connection member 700, and as a result, the droplets may be prevented from leaking through a space which the heat insulating structure 400 penetrates.

According to an embodiment, at least some regions of the electrical connection member 700 may be formed in a bent or curved shape so that the electrical connection member 700 may be arranged to avoid the heat insulating structure 400. However, the shape of the electrical connection member 700 is not limited to the above-described embodiment.

Referring to FIG. 7B, a housing 100 (e.g., the housing 100 of FIGS. 2, 3A and/or 5A) of the aerosol generating apparatus 10 according to an embodiment may further include a guide groove 101 for supporting or fixing an electrical connection member 700.

According to an embodiment, the guide groove 101 may be formed on an inner side surface 100i of the housing 100 to support or fix the electrical connection member 700 accommodated in the guide groove 101. For example, the electrical connecting member 700 may be fitted on the guide groove 101 and supported or fixed by the guide groove 101, but embodiments are not limited thereto.

According to another embodiment, the aerosol generating apparatus 10 may include at least one protrusion member that protrudes in a direction toward the electrical connection member 700 from the inner side surface 100i of the housing 100.

At least one protrusion member may be, for example, in contact with one region of the electrical connection member 700 to support the electrical connection member 700. As a result, the position of the electrical connection member 700 may be fixed during using of the aerosol generating apparatus 10.

FIG. 8 is a block diagram illustrating some components of an aerosol generating apparatus according to an embodiment.

Referring to FIG. 8, an aerosol generating apparatus 10 according to an embodiment may include a pressure sensor 500 (e.g., the pressure sensor 500 of FIG. 3A and/or FIG. 5A), a processor 610 (e.g., the processor 610 of FIGS. 2 and 7), and a display D (e.g., the display D of FIG. 1).

The processor 610 may be electrically connected to the pressure sensor 500 and may detect the user's puff operation based on the pressure change of an air flow path (e.g., the first chamber 300 of FIG. 3A) and/or an air chamber (e.g., the second chamber 320 of FIG. 5A) detected by the pressure sensor 500.

For example, during the user's puff operation, a pressure difference between the inside and the outside of the aerosol generating apparatus 10 may occur so that at least a portion of the inside air of the aerosol generating apparatus 10 may be discharged to the outside of the aerosol generating apparatus 10 and thus a pressure drop may occur in the air flow path and/or the air chamber.

Thus, the processor 610 may detect the users puff operation based on the pressure drop of the air flow path and/or the air chamber detected by the pressure sensor 500. For example, when the pressure drop of the air flow path and/or the air chamber is greater than or equal to a designated value, the processor 610 may determine that the user's puff operation has been performed or has occurred.

The pressure drop of the air flow path and/or the air chamber may occur by noise generated during the operation of the aerosol production apparatus 10, even without a user's puff operation. The aerosol generating apparatus 10 according to an embodiment may determine that the user's puff operation has been performed or has occurred when the pressure drop of the air flow path and/or the air chamber is greater than or equal to the designated value, so that the user's puff operation may be more accurately measured.

The processor 610 may output a notification (or a ‘user notification’) indicating that the user's puff operation has occurred, based on a determination that the user's puff operation has been performed.

The notification may include, for example, at least one of a visual notification notifying that the user's puff operation has occurred through visual information, an audio notification notifying that the user's puff operation has occurred through audio information (e.g., a sound), and a tactile notification notifying that the user's puff operation has occurred through tactile information (e.g., vibration). However, embodiments are not limited thereto.

In an example, the processor 610 may display a notification indicating that the user's puff operation has occurred through the display D and/or a light emitting diode (LED), thereby outputting a notification indicating that the user's puff operation has occurred.

In another example, the processor 610 may output a notification indicating that the user's puff operation has occurred, by generating a sound through a speaker. In another example, the processor 610 may output a notification indicating that the user's puff operation has occurred, by generating a vibration through a motor and/or an actuator.

Furthermore, the processor 610 may calculate or count the number of times of remaining puffs of an aerosol production article (e.g., the aerosol production article 20 of FIG. 2) inserted into the aerosol generating apparatus 10 based on the user's puff numbers and may output notifications corresponding to the number of times of remaining puffs to the user.

According to an embodiment, when it is determined that the user's puff operation has been performed, the processor 610 may count the user's puff number and may calculate the number of times of remaining puffs of the aerosol generating article inserted into the aerosol generating apparatus 10 through a difference between a preset total number of times of puffs of the aerosol generating article and the counted number of times of user's puffs.

For example, the processor 610 may calculate the number of times of remaining puffs of the inserted aerosol generating article when the preset total number of times of puffs of the aerosol generating article is 14 times and the counted number of times of user's puffs is 4 times.

The processor 610 may provide information about the number of times of remaining puffs to the user through, for example, at least one notification of the visual notification, the audio notification, and the tactile notification. However, embodiments are not limited thereto.

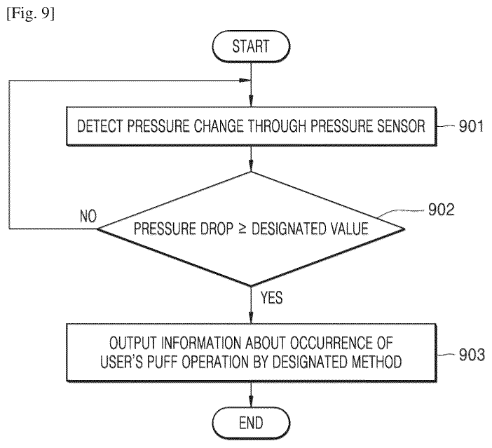

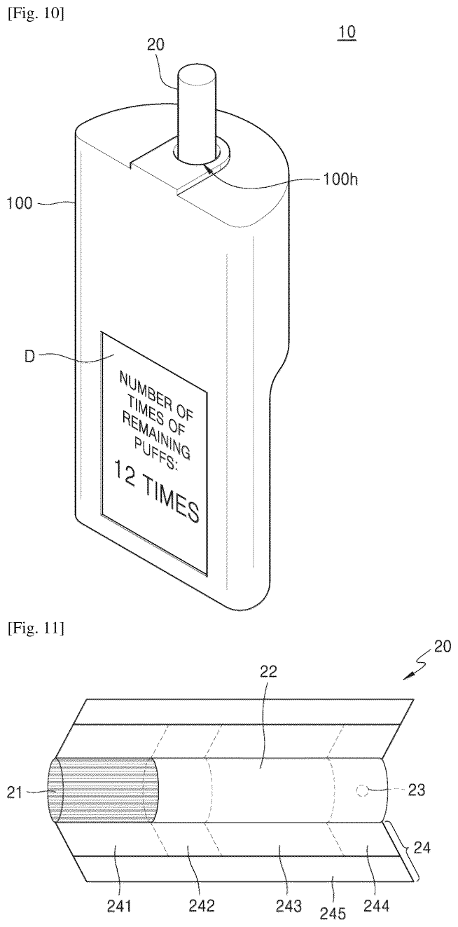

FIG. 9 is a flowchart for describing a process of detecting the user's puff operation of an aerosol generating apparatus according to an embodiment, and FIG. 10 is a view for describing a state in which a visual notification is provided through a display in the aerosol generating apparatus according to an embodiment.

Hereinafter, when describing the process of detecting the user's puff operation of the aerosol generating apparatus shown in FIG. 9, components of the aerosol generating apparatus 10 shown in FIGS. 3A, 5A and/or 8 will be referred to.

Referring to FIG. 9, in operation 901, the aerosol generating apparatus 10 according to an embodiment may detect a pressure change of a first chamber 300 (e.g., the first chamber 300 of FIG. 3A) and/or a second chamber 320 (e.g., the second chamber 320 of FIG. 5A) through a pressure sensor 500 (e.g., the pressure sensor 500 of FIG. 3A and/or 5A).

Information about the pressure change of the first chamber 300 and/or the second chamber 320 may be detected by the pressure sensor 500 and may be transmitted from the pressure sensor 500 to the processor 610.

In operation 902, a processor 610 of the aerosol generating apparatus 10 according to an embodiment may compare the pressure change of the first chamber 300 and/or the second chamber 320 detected in operation 901 with a designated value so as to detect the user's puff operation.

In the present disclosure, the ‘designated value’ may mean a pressure drop that is a base (or a reference value) for detecting the user's puff operation, and the corresponding expression may be used in the same sense. The above-described designated value may be a value stored in the processor 610 or memory of the aerosol generating apparatus 10, and the designated value may vary according to the user's manipulation.

For example, during the user's puff operation, a pressure difference between the inside and the outside of the aerosol generating apparatus 10 may occur so that at least a portion of the inside air of the aerosol generating apparatus 10 may be discharged to the outside of the aerosol generating apparatus 10 and thus a pressure drop may occur in the first chamber 300 and/or the second chamber 320.

Thus, the processor 610 may compare the pressure drop of the first chamber 300 and/or the second chamber 320 with the designated value (e.g., the designated value ΔP of FIGS. 4 and 6) so as to detect the user's puff operation and may determine whether the pressure drop of the first chamber 300 and/or the second chamber 320 is greater than or equal to the designated value.

In operation 903, the processor 610 of the aerosol generating apparatus 10 according to an embodiment may output the occurrence of the user's puff operation by a designated method when the pressure drop of the first chamber 300 and/or the second chamber 320 is greater than or equal to the designated value.

The designated method may include, for example, at least one of a method of providing a visual notification through the display D and/or an LED, a method of providing an audio notification (e.g., a sound) through a speaker, and a method of providing a tactile notification (e.g., vibration) through a motor and/or an actuator. However, embodiments are not limited thereto.

According to an embodiment, when, in operation 902, it is determined that the pressure drop of the first chamber 300 and/or the second chamber 320 is greater than or equal to the designated value, the processor 610 may determine that the user's puff operation has been performed, and may provide a notification regarding the occurrence of the user's puff operation to the user.

Unlike this, when the pressure drop of the first chamber 300 and/or the second chamber 320 is less than the designated value, the processor 610 of the aerosol generating apparatus 10 according to an embodiment may determine that a pressure drop has occurred by noise or there is no pressure change, and may perform operations 901 and 902 again.

The processor 610 of the aerosol generating apparatus 10 according to an embodiment may calculate the number of times of remaining puffs of the aerosol generating article 20 based on the number of times of user's puffs, and may provide a user's notification corresponding to the number of times of remaining puffs to the user.

For example, when it is determined that the user's puff operation has been performed, the processor 610 may count the number of times of user's puffs and may calculate the number of times of remaining puffs of the aerosol generating article 20 based on a difference between a preset total number of times of puffs of the aerosol generating article 20 and the counted number of times of user's puffs.

The processor 610 may output notifications corresponding to the number of times of remaining puffs of the aerosol generating article 20 calculated through the above-described process by various methods.

According to an embodiment, the processor 610 may be electrically or operatively connected to the display D arranged in at least one region of the outer circumferential surface of the housing 100 to output a visual notification corresponding to the number of times of remaining puffs through the display D, as shown in FIG. 10.

For example, the processor 610 may display the number of times of remaining puffs on the display D, thereby notifying information about the number of times of remaining puffs of the aerosol generating article 20 to the user. However, the visual information displayed on the display D is not limited to the embodiment shown in FIG. 10, and when information about the number of times of remaining puffs is notified to the user, the visual information displayed on the display D may vary.

According to another embodiment, the processor 610 may notify information about the number of times of remaining puffs to the user through an audio and/or tactile sense. For example, the processor 610 may provide information about the number of times of remaining puffs to the user through an audio notification for generating a sound corresponding to the number of times of remaining puffs or a tactile notification for generating vibration corresponding to the number of times of remaining puffs.

According to another embodiment, the processor 610 may provide information about the number of times of remaining puffs to the user through at least two of the visual notification, the audio notification, and the tactile notification. For example, the processor 610 may provide the visual notification and the audio notification simultaneously or may provide all of the visual notification, the audio notification, and the tactile notification.

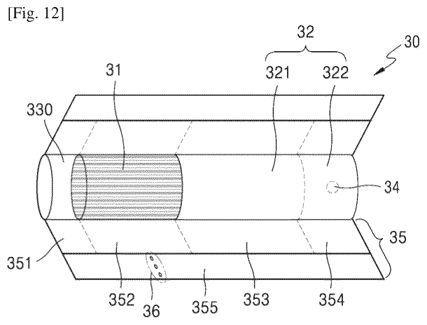

Hereinafter, examples of an aerosol generating article will be described with reference to FIGS. 11 and 12.

FIG. 11 is a view illustrating an aerosol generating article according to an embodiment, and FIG. 12 is a view illustrating an aerosol generating article according to another embodiment.

Referring to FIG. 11, the cigarette 20 may include a tobacco rod 21 and a filter rod 22.

FIG. 11 illustrates that the filter rod 22 includes a single segment. However, the filter rod 22 is not limited thereto. In other words, the filter rod 22 may include a plurality of segments. For example, the filter rod 22 may include a first segment configured to cool an aerosol and a second segment configured to filter a certain component included in the aerosol. Also, according to necessity, the filter rod 22 may further include at least one segment configured to perform other functions.

The cigarette 20000 may be packaged via at least one wrapper 24. The wrapper 24 may have at least one hole through which external air may be introduced or internal air may be discharged. For example, the cigarette 20 may be packaged via one wrapper 24. As another example, the cigarette 20 may be doubly packaged via at least two wrappers 24. For example, the tobacco rod 21 may be packaged via a first wrapper 241, and the filter rod 22 may be packaged via wrappers 242, 243, 244. Also, the entire cigarette 20 may be packaged via a single wrapper 245. When the filter rod 22 includes a plurality of segments, each segment may be packaged via separate wrapper 242, 243, 244.

The tobacco rod 21 may include an aerosol generating material. For example, the aerosol generating material may include at least one of glycerin, propylene glycol, ethylene glycol, dipropylene glycol, diethylene glycol, triethylene glycol, tetraethylene glycol, and oleyl alcohol, but it is not limited thereto. Also, the tobacco rod 21 may include other additives, such as flavors, a wetting agent, and/or organic acid. Also, the tobacco rod 21 may include a flavored liquid, such as menthol or a moisturizer, which is injected to the tobacco rod 21.

The tobacco rod 21 may be manufactured in various forms. For example, the tobacco rod 21 may be formed as a sheet or a strand. Also, the tobacco rod 21 may be formed as a pipe tobacco, which is formed of tiny bits cut from a tobacco sheet. Also, the tobacco rod 21 may be surrounded by a heat conductive material. For example, the heat-conducting material may be, but is not limited to, a metal foil such as aluminum foil. For example, the heat conductive material surrounding the tobacco rod 21 may uniformly distribute heat transmitted to the tobacco rod 21, and thus, the heat conductivity applied to the tobacco rod may be increased and taste of the tobacco may be improved. Also, the heat conductive material surrounding the tobacco rod 21 may function as a susceptor heated by the induction heater. Here, although not illustrated in the drawings, the tobacco rod 21 may further include an additional susceptor, in addition to the heat conductive material surrounding the tobacco rod 21.

The filter rod 22 may include a cellulose acetate filter. Shapes of the filter rod 22 are not limited. For example, the filter rod 22 may include a cylinder-type rod or a tube-type rod having a hollow inside. Also, the filter rod 22 may include a recess-type rod. When the filter rod 22 includes a plurality of segments, at least one of the plurality of segments may have a different shape.

Also, the filter rod 22 may include at least one capsule 23. Here, the capsule 23 may generate a flavor or an aerosol. For example, the capsule 23 may have a configuration in which a liquid containing a flavoring material is wrapped with a film. For example, the capsule 23 may have a spherical or cylindrical shape, but is not limited thereto.

Referring to FIG. 12, the cigarette 30 may further include a front-end plug 33. The front-end plug 33 may be located on a side of the tobacco rod 31, the side facing the filter rod 32. The front-end plug 33 may prevent the tobacco rod 31 from being detached outwards and prevent a liquefied aerosol from flowing into the aerosol generating device from the tobacco rod 31, during smoking.

The filter rod 32 may include a first segment 321 and second segment 322. Here, the first segment 321 can correspond to a first segment of a filter rod 22 of FIG. 11, and the second segment 322 can correspond to a third segment of a filter rod 22 of FIG. 11.

The diameter and total length of the cigarette 30 can correspond to the diameter and total length of the cigarette 20 of FIG. 11. For example, the length of the front-end plug 33 may be about 7 mm, the length of the tobacco rod 31 may be about 15 mm, the length of the first segment 321 may be about 12 mm, and the length of the second segment 322 may be about 14 mm, but it is not limited to this.

The cigarette 30 may be packaged via at least one wrapper 35. The wrapper 35 may have at least one hole through which external air may be introduced or internal air may be discharged. For example, the front-end plug 33 may be packaged via a first wrapper 351, and the tobacco rod 31 may be packaged via a second wrapper 352, and the first segment 321 may be packaged via a third wrapper 353, and the second segment 322 may be packaged via a fourth wrapper 354. Also, the entire cigarette 30 may be packaged via a fifth wrapper 355.

Also, the fifth wrapper 355 may have at least one hole 36. For example, the hole 36 may be formed in an area surrounding the tobacco rod 31, but is not limited thereto. The hole 36 may serve to transfer heat formed by the heater 200 shown in FIG. 2 to the inside of the tobacco rod 31.

Also, the second segment 322 may include at least one capsule 34. Here, the capsule 34 may generate a flavor or an aerosol. For example, the capsule 34 may have a configuration in which a liquid containing a flavoring material is wrapped with a film. For example, the capsule 34 may have a spherical or cylindrical shape, but is not limited thereto.

Those of ordinary skill in the art related to the present embodiments may understand that various changes in form and details can be made therein without departing from the scope of the characteristics described above. The disclosed methods should be considered in a descriptive sense only and not for purposes of limitation. Therefore, the scope of the disclosure should be defined by the appended claims, and all differences within the scope equivalent to those described in the claims will be construed as being included in the scope of protection defined by the claims.

1. An aerosol generating apparatus comprising:
a housing comprising a first chamber into which an aerosol generating article is inserted, a second chamber spaced apart from the first chamber, and an air path provided between the first chamber and the second chamber;
a pressure sensor configured to detect a pressure in the second chamber; and
a processor configured to obtain pressure sensing data from the pressure sensor, detect a pressure change inside the second chamber based on the pressure sensing data, and output a notification indicating that a user's puff operation has occurred when the pressure change inside the second chamber is greater than or equal to a designated value.

2. The aerosol generating apparatus of claim 1, further comprising a heater configured to heat the aerosol generating article inserted into the first chamber to generate an aerosol.

3. The aerosol generating apparatus of claim 2, further comprising a heat insulating structure arranged to surround an outer circumferential surface of the heater and configured to seal the heater and to prevent dissipation of heat generated in the heater.

4. The aerosol generating apparatus of claim 3, wherein the pressure sensor is spaced apart from the heat insulating structure.

5. The aerosol generating apparatus of claim 3, further comprising an electrical connector arranged to bypass the heat insulating structure and configured to electrically connect the pressure sensor to the processor.

6. The aerosol generating apparatus of claim 1, wherein the pressure sensor is located on a top end of the second chamber and is connected to an inside of the second chamber.

7. The aerosol generating apparatus of claim 1, further comprising:
a sensor bracket that supports the pressure sensor, and comprises a through hole through which the pressure sensor and the second chamber are connected to each other;
a sensor cover arranged to cover at least a portion of an outer circumferential surface of the pressure sensor and configured to dissipate heat transferred to the pressure sensor; and
a protective member arranged to surround at least a portion of the outer circumferential surface of the pressure sensor between the sensor bracket and the sensor cover and configured to prevent leakage of air introduced into the pressure sensor.

8. The aerosol generating apparatus of claim 2, wherein the heater comprises:
a coil configured to generate an alternating magnetic field; and a susceptor configured to generate heat in response to the alternating magnetic field generated in the coil to heat the aerosol generating article.

9. The aerosol generating apparatus of claim 1, wherein the processor is further configured to output the notification indicating that the user's puff operation has occurred, when a pressure drop of air inside of the second chamber is greater than or equal to the designated value.

10. The aerosol generating apparatus of claim 1, wherein the notification comprises at least one of a visual notification, an audio notification, and a tactile notification.

11. The aerosol generating apparatus of claim 10, further comprising a display, wherein the processor is further configured to display the notification indicating that the user's puff operation has occurred through the display.

12. The aerosol generating apparatus of claim 1, wherein the processor is further configured to output an additional notification indicating that a number of times of remaining puffs of the inserted aerosol generating article based on a number of times of an occurrence of the user's puff operation.

13. An aerosol generating apparatus comprising:
a housing comprising a chamber into which an aerosol generating article is inserted, and an air path diverging from one point of the chamber in a direction crossing the chamber,
a heater configured to heat the aerosol generating article inserted into the chamber to generate an aerosol;
a pressure sensor configured to detect a pressure in the chamber, and
a processor configured to obtain pressure sensing data from the pressure sensor, detect a pressure change of the chamber based on the pressure sensing data, and output a notification indicating that a user's puff operation has occurred when the pressure change inside the chamber is greater than or equal to a designated value.

14. The aerosol generating apparatus of claim 13, further comprising a heat insulating structure arranged to surround an outer circumferential surface of the heater and configured to seal the heater to prevent dissipation of heat generated in the heater.

15. The aerosol generating apparatus of claim 14, wherein the pressure sensor is spaced apart from the heat insulating structure.
